(19) United States
(12) Patent Application Publication
(10) Pub. No.: US 2018/0271085 A1
(43) Pub. Date: Sep. 27, 2018

(54) AUTOMATIC RECHARGEABLE TRAP CONFIGURED FOR DETERMINING ITS RATS AND MICE KILLS

(71) Applicant: Skehøjgaard Development ApS

(72) Inventor: Kurt Sørensen, Nørager (DK)

(21) Appl. No.: 15/933,190

(22) Filed: Mar. 22, 2018

(30) Foreign Application Priority Data
Mar. 24, 2017 (EP) 17162722.7
May 1, 2017 (EP) 17168882.3
May 5, 2017 (EP) 17169724.6

(51) Int. Cl. A01M 31/00; A01M 23/14; A01M 23/30; A01M 23/38

(52) U.S. Cl. CPC A01M 31/002; A01M 23/38; A01M 23/30; A01M 23/14

(57) ABSTRACT

The present invention relates to an automatic rechargeable trap comprising a spring driven and/or gas pressure driven killing means; and species monitoring means configured for determining the species by monitoring the degree of advancement of the killing means during an individual triggering.

### RELATED APPLICATIONS

This application claims priority to, and the benefit of, European Application Nos. 17162722.7, filed Mar. 24, 2017, 17168882.3, filed May 1, 2017 and 17169724.6, filed May 5, 2017, the entire teachings of which are incorporated by reference herein.

### Technical Field of the Invention

The present invention relates to automatic rechargeable killing traps.

### Background of the Invention

Urban environments provide suitable conditions for certain species of rodents, particularly Norway rats and house mice, to proliferate. Mice and rats generally pose a health hazard due to disease spreading. Rat urine per se presents an additional health hazard because of the potential presence of Leptospira spp., which can enter the blood through skin cuts causing the potentially fatal Weil's disease. In addition, presence of rats and mice often impose a significant economic cost through the potential destruction of building materials, such as wall and roof insulation, electrical wiring, packaging, and contaminating foods etc. Rats are much worse than mice in regard to both disease spreading and destruction of building materials. To devise and target efficient pest control strategies, it is essential to have a reliable and sensitive method of identifying the presence and location of rats and mice in the environment and of identifying the species concerned.

Conventional methods of detection rely on an infestation reaching large enough proportions to show physical signs, the presence of faeces and signs of gnawing damage are the most commonly used. Whilst such signs can be reliable, they usually identify an infestation that is well established, which will be difficult to eradicate and could already have caused much damage. Small numbers of rats and mice will not always leave such obvious signs in visible sites. Droppings from mice are often difficult to spot, while those from rats are usually located in small numbers of latrine sites. Therefore, whilst such methods can be reliable for detecting large scale infestations, they are usually inadequate for detecting the presence of rodents at a low level.

### OBJECT OF THE INVENTION

The objective of the present invention is to provide an automatic rechargeable trap suitable for use in a system for detecting and predicting rats and mice infestations, which alleviates or mitigates the disadvantages associated with prior art methods.

### DESCRIPTION OF THE INVENTION

One aspect of the present invention relates to an automatic rechargeable trap comprising:
a) a spring driven and/or gas pressure driven killing means; and
b) species monitoring means configured for determining the species by monitoring the degree of advancement of the killing means during an individual triggering.

Mechanical traps are characterised by killing means that strikes the rodent and almost instantly kills the rodent. The killing means in mechanical traps are normally spring driven or gas pressure driven, and may be recharged by electrical means or gas pressure driven means.

The species monitoring means is configured for determining the species by monitoring the degree of advancement of the killing means during an individual triggering. If a mouse has activated the killing means, the killing means will travel a longer distance than for a rat due to the difference in size. Hence, this method of distinguishing between mice and rats is simple and reliable. The information about an individual trap may be collected and used in analysing the rat and/or mice activity in a selected geographical area, where several traps are positioned.

In one or more embodiments, the automatic rechargeable trap further comprises a kill monitoring means configured for determining the number of kills by monitoring the number of triggering of the killing means. The kill monitoring means should simply be able to detect each time the killing means is activated. The kill monitoring means could be embodied as e.g. a shock sensor, or a motion sensor.

In one or more embodiments, the automatic rechargeable trap further comprises a transmitter unit configured for receiving monitoring data from the species monitoring means and/or from the kill monitoring means, and configured for transmitting the received monitoring data. The transmitter unit is configured for receiving monitoring data from the species monitoring means and from the kill monitoring means, and configured for transmitting the received monitoring data. The signal may be transmitted by e.g. satellite, 4G, 3G, 5G, radio link, GSM, LTE, UMTS and/or through an internet-of-things (IoT) network.

In one or more embodiments, the automatic rechargeable trap further comprises a housing with a rat and mouse entry opening positioned in the side wall and/or in the bottom wall; and wherein the spring driven and/or gas pressure driven killing means is positioned at a level above the level of the rat and/or mouse entry opening, such that a rat or mouse can reach the killing means when standing within the housing on their hind legs.

In one or more embodiments, the spring driven and/or gas pressure driven killing means comprises a piston, and wherein the piston, after a triggered release, is configured to hold its position for a predefined period of time. The predefined time period may be milliseconds (e.g. 10-500 milliseconds) or a few seconds (e.g. 0.5-3 seconds), such as 0.01-5 seconds. This configuration is to secure that the rodent is killed. The species monitoring means may then be configured for monitoring the degree of advancement of the piston during the predefined period of time that the piston holds its position during a triggered release.

In one or more embodiments, the automatic rechargeable trap further comprises a counter configured for calculating the number of rats and mice killed by said killing means during a period of time.

In one or more embodiments, the spring driven and/or gas pressure driven killing means comprises a piston, and wherein the piston, after a triggered release, is returned to a charged position within a piston bore by a motor, and wherein a) the motor operating time needed to return the piston to a charged position and/or b) the force needed by the motor to return the piston to a charged position and/or c) the number of motor shaft revolutions needed to return the piston to a charged position and/or d) measuring the power consumption needed to return the piston to a charged position, are used by the species monitoring means for monitoring the degree of advancement of the piston.

In one or more embodiments, the species monitoring means is configured for differentiating between rats and mice by using the degree of advancement of the piston during a triggered release.

A second aspect of the present invention relates to a piston unit for an automatic rechargeable mechanical trap comprising:
a piston; and
a piston bore;
   wherein the piston bore comprises:
a1) a threaded cylindrical rod adapted to rotate around its central axis within the piston bore cavity; wherein the first end of the threaded cylindrical rod is adapted for engagement with a motor unit, and wherein the second end is a free end;
b1) a spring positioned within the piston bore cavity, and around or alongside the threaded cylindrical rod; and
c1) a lock plate comprising i) a threaded opening configured for receiving the threaded cylindrical rod; and ii) a protrusion extending radially away from the threaded opening; and wherein the piston comprises:
a2) a central channel adapted for receiving the threaded cylindrical rod, and wherein the upper part of the central channel further comprises a recess configured for receiving a protrusion of the lock plate; wherein the bottom part of the recess comprises a cavity configured for receiving said protrusion of the lock plate in a locking configuration when the lock plate is rotated around the central axis of the threaded cylindrical rod. This piston unit may in one or more embodiments be used as the killing means of the first aspect of the invention.

The piston bore is adapted for holding a piston that moves out of and moves within the piston bore cavity during the triggering and recharging operations.

The piston bore comprises a threaded cylindrical rod adapted to rotate around its central axis within the piston bore cavity. The first end of the threaded cylindrical rod is adapted for engagement with a motor unit of a trap, and the second end is a free end. The piston bore also comprises a spring positioned within the piston bore cavity, and around or alongside the threaded cylindrical rod. The spring is compressed when the piston unit is charged, and partly forces the piston out of the piston bore cavity when the piston bore is triggered to release. The piston will thereby break the neck of the rodent.

The piston bore further comprises a lock plate comprising i) a threaded opening configured for receiving the threaded cylindrical rod; and ii) a protrusion extending radially away from the threaded opening. The lock plate can thereby move up and down the threaded cylindrical rod when the threaded cylindrical rod is rotated. The protrusion is used to lock the piston to the piston bore.

The piston comprises a central channel adapted for receiving the free end of the threaded cylindrical rod. This configuration allows for the piston to enter the piston bore cavity. The upper part of the central channel further comprises a recess configured for receiving a protrusion of the lock plate. There may be multiple protrusions and multiple recesses. The bottom part of a recess comprises a cavity configured for receiving the protrusion of the lock plate in a locking configuration when the lock plate is rotated around the central axis of the threaded cylindrical rod. Thereby, the protrusion is moved out of the recess and into the cavity, why the lock plate cannot move—it is locked to the cavity. The cavity serves two functions. The first function is when the piston unit is in a charged state, where the piston is retracted into the piston bore cavity, and the spring is compressed. Here, the cavity serves as a part of the trigger. When the protrusion is moved out of the cavity during a triggering, the piston is forced out of the piston bore. The cavity displaces the same distance as the piston, as it is part thereof. In order to recharge the piston unit, the lock plate must find its way back to the cavity. This is done by continuing to rotate the threaded cylindrical rod, whereby the lock plate travels towards the free end of said threaded cylindrical rod until it reaches the bottom of the recess, and the protrusion enters the cavity. The rotation of the threaded cylindrical rod must then be reversed in order for the lock plate to retract the piston into the piston bore.

In one or more embodiments, the piston further comprises a peripheral channel running peripherally to the central channel, and configured for receiving one of the spring end portions. This configuration allows for a very compact unit.

In one or more embodiments, the first end of the threaded cylindrical rod is configured as a toothed wheel adapted for engagement with a motor unit.

In one or more embodiments, the inner surface of the piston bore comprises one or more guide tracks, and wherein the outer surface of the piston comprises one or more protrusions configured for slidably engaging with said guide tracks. The guide tracks and the protrusions are preferably running in the longitudinal direction of the piston unit.

In one or more embodiments, the outer surface of the piston comprises one or more guide tracks, and wherein the inner surface of the piston bore comprises one or more protrusions configured for slidably engaging with said guide tracks. The guide tracks and the protrusions are preferably running in the longitudinal direction of the piston unit.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a perspective view of an automatic rechargeable trap in accordance with various embodiments of the invention;

FIG. 2 is a cross-section of an automatic rechargeable trap in accordance with various embodiments of the invention;

FIG. 3 shows a side view of a piston unit in a charged position in accordance with various embodiments of the invention, as well as a cross-section of said view;

FIG. 4 shows a perspective view of the cross-section in FIG. 3;

FIG. 5 shows a side view of a piston unit in a released position in accordance with various embodiments of the invention, as well as a cross-section of said view;

FIG. 6 shows a perspective view of the cross-section in FIG. 5;

FIG. 7 shows a close-up view of FIG. 6;

FIG. 8 shows a side view of a piston unit during a recharging operation in accordance with various embodiments of the invention, as well as a cross-section (A-A) of said view;

FIG. 9 shows a perspective view of the cross-section in FIG. 8;

FIG. 10 shows a close-up view of FIG. 9;

FIG. 11 shows a cross-section (B-B) of the piston unit in FIG. 8, as well as a perspective view of said cross-section (B-B);

FIG. 12 shows a perspective view of an automatic rechargeable trap comprising a killing means comprising a piston unit in accordance with various embodiments of the invention; and

FIG. 13 is a cross-section of an automatic rechargeable trap comprising a killing means comprising a piston unit in accordance with various embodiments of the invention.

### REFERENCES

100 Automatic rechargeable trap

110 Motor unit

120 Housing

130 Rat and mouse entry opening

140 Side wall

150 Base wall

160 Trigger rod

200 Spring driven and/or gas pressure driven killing means, or piston unit

210 Piston

211 Central channel

212 Recess

214 Cavity

220 Peripheral channel

230 Protrusion

300 Piston bore

310 Threaded cylindrical rod

312 First end

313 Toothed wheel

314 Second end

320 Spring

330 Lock plate

332 Protrusion

340 Guide track

400 Species monitoring means

### DETAILED DESCRIPTION OF THE INVENTION

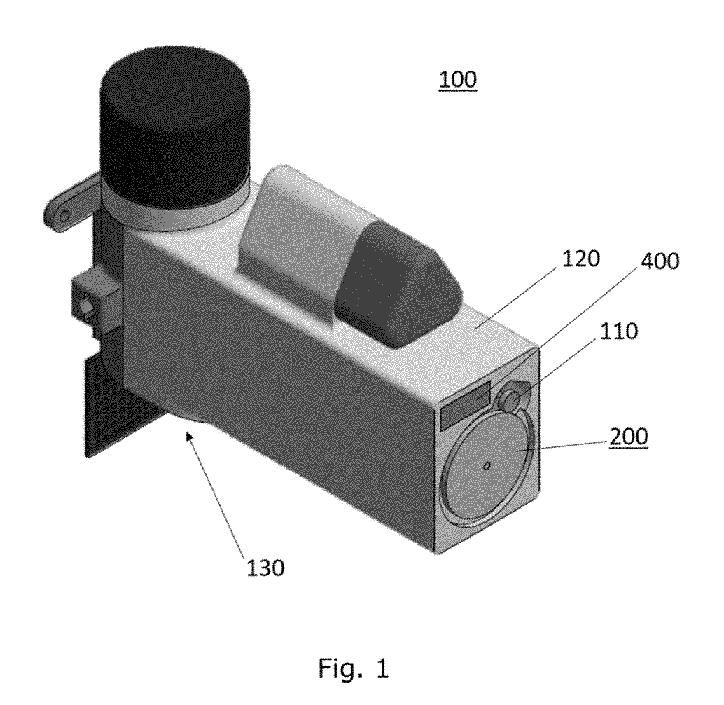

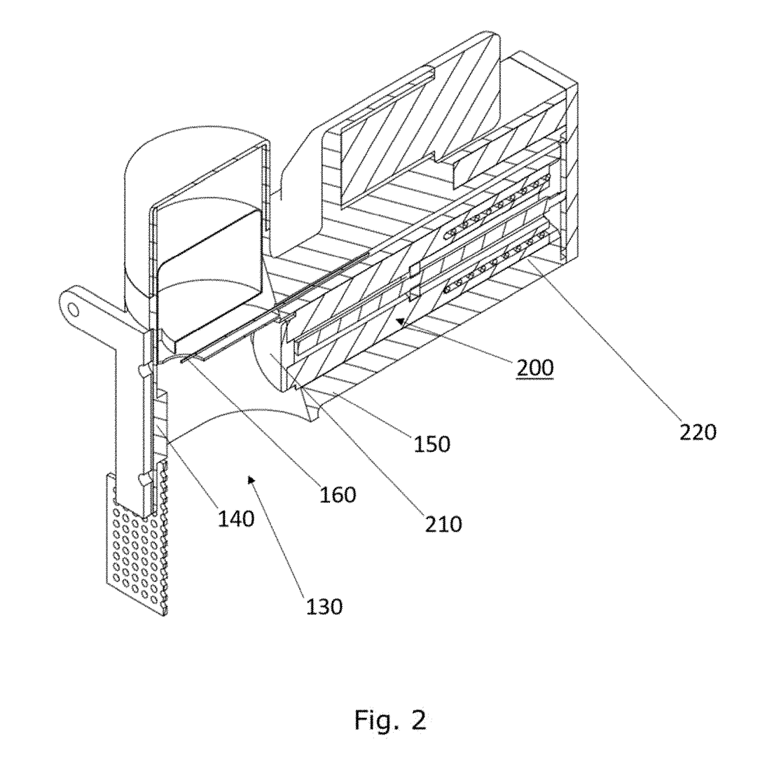

FIG. 1 shows a perspective view of an automatic rechargeable trap in accordance with various embodiments of the invention. The automatic rechargeable trap 100 comprises a spring driven and/or gas pressure driven killing means 200; and species monitoring means 400 configured for determining the species by monitoring the degree of advancement of the killing means 200 during an individual triggering. The automatic rechargeable trap is shown comprising a housing 120 with a rat and mouse entry opening 130 positioned in the side wall 140 and in the bottom wall 150 (FIG. 2). FIG. 2 is a cross-section of an automatic rechargeable trap. The spring driven and/or gas pressure driven killing means 200 is positioned at a level above the level of the rat and mouse entry opening 130, such that a rat or mouse can reach the killing means when standing within the housing 120 on their hind legs, while activating a trigger rod 160 with its head.

The spring driven and/or gas pressure driven killing means 200 comprises a piston 210 supported by a piston bore 300. After a triggered release, the piston 210 is returned to a charged position within the piston bore 300 by a motor unit 110.

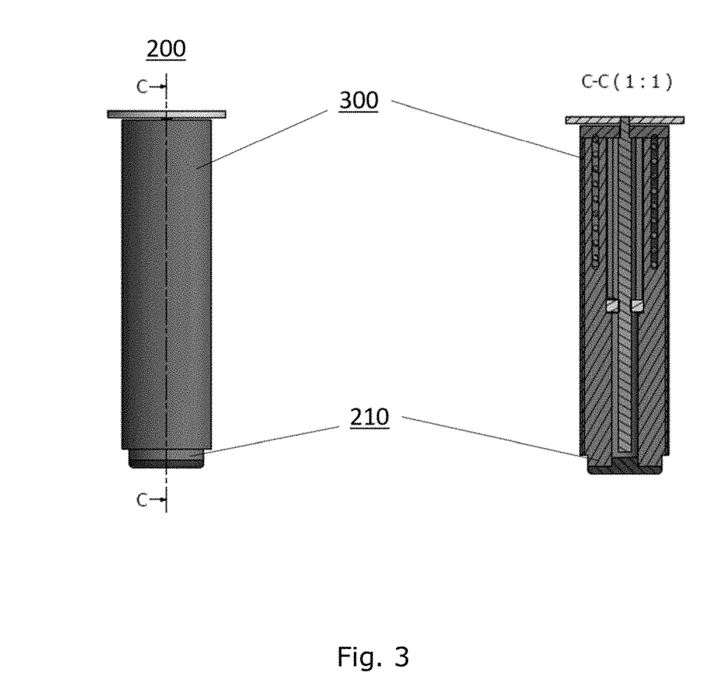

FIG. 3 shows a side view of a piston unit 200 (killing means) in a charged position, as well as a cross-section of said view. The piston unit 200 comprises a piston 210 and a piston bore 300.

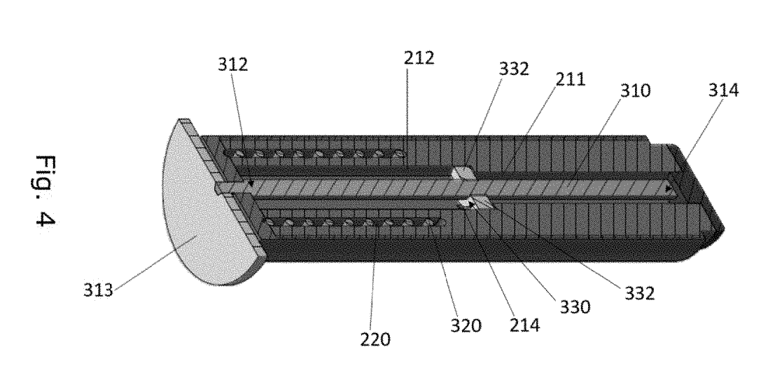

FIG. 4 shows a perspective view of the cross-section in FIG. 3. The piston bore 300 comprises a threaded cylindrical rod 310 adapted to rotate around its central axis within the piston bore cavity. The first end 312 of the threaded cylindrical rod 310 is adapted for engagement with a motor unit, and the second end 314 is a free end. The piston bore 300 also comprises a spring 320 positioned within the piston bore cavity, and around the threaded cylindrical rod 310. The piston bore 300 further comprises a lock plate 330 comprising a threaded opening (the threaded cylindrical rod 310 is positioned therein) configured for receiving the threaded cylindrical rod 310; and a protrusion 332 extending radially away from the threaded opening (here shown in a configuration with two protrusions).

The piston 210 comprises a central channel 211 adapted for receiving the threaded cylindrical rod 310. The upper part of the central channel 211 further comprises a recess 212 configured for receiving a protrusion 332 of the lock plate 330. The bottom part of the recess 212 comprises a cavity 214 configured for receiving the protrusion 332 of the lock plate 330 in a locking configuration when the lock plate 330 is rotated around the central axis of the threaded cylindrical rod 310.

The first end 312 of the threaded cylindrical rod 310 is configured as a toothed wheel 313 (the teeth are not shown) adapted for engagement with a motor unit.

The piston 210 is also shown with a peripheral channel 220 running peripherally to the central channel 211, and configured for receiving one of the spring 320 end portions. The spring 320 is compressed when the piston unit 200 is charged, and partly forces the piston 210 out of the piston bore cavity when the piston bore 300 is triggered to release. The piston 210 will thereby break the neck of the rodent.

The cavity 214 serves two functions. The first function is when the piston unit 200 is in a charged state, where the piston 210 is retracted into the piston bore cavity, and the spring 320 is compressed. Here, the cavity 214 serves as a part of the trigger. When the protrusion 332 is moved out of the cavity 214 during a triggering, the piston 210 is forced out of the piston bore 300.

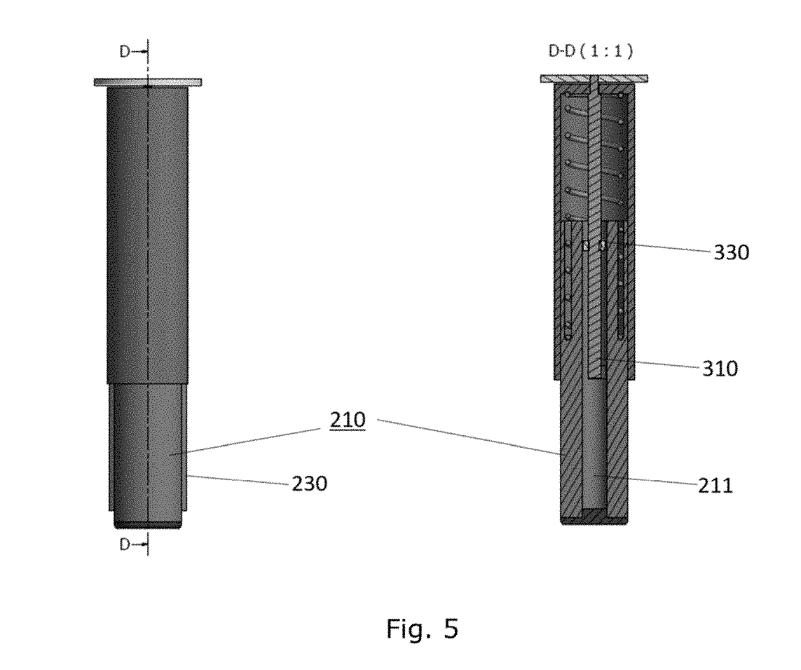

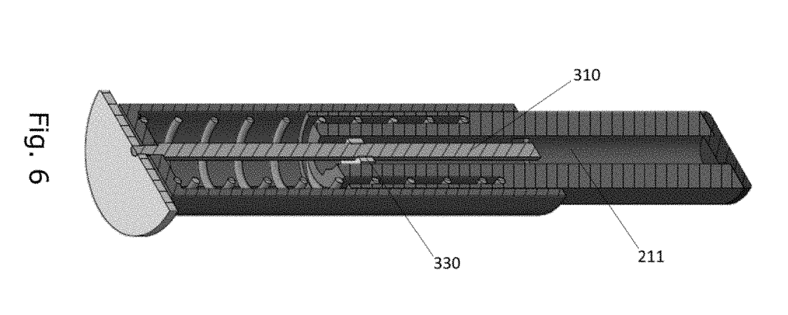

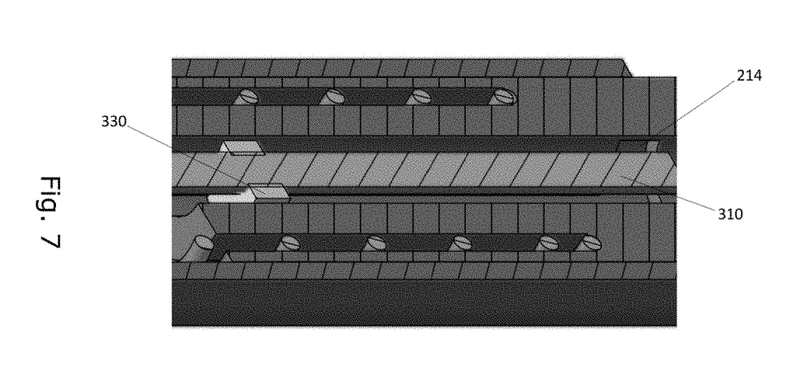

FIG. 5 shows a side view of a piston unit in a released position in accordance with various embodiments of the invention, as well as a cross-section of said view. FIG. 6 shows a perspective view of the cross-section in FIG. 5, and FIG. 7 shows a close-up view of FIG. 6.

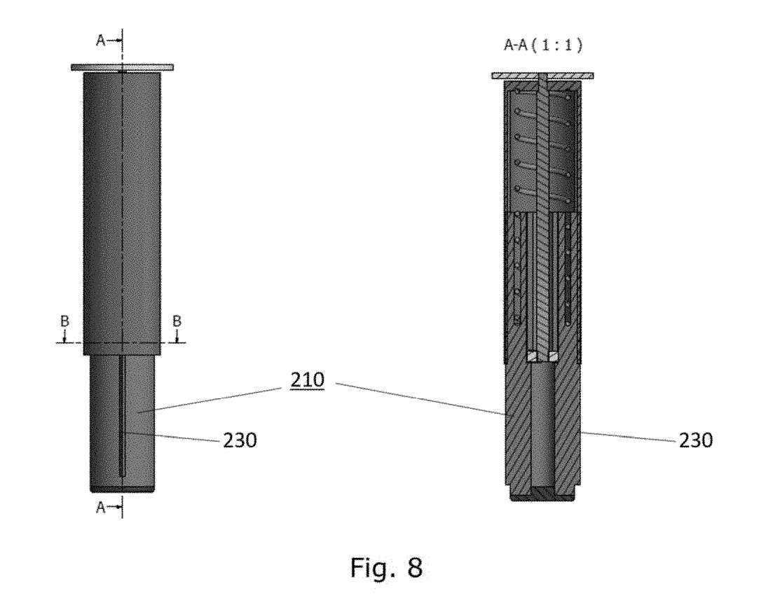

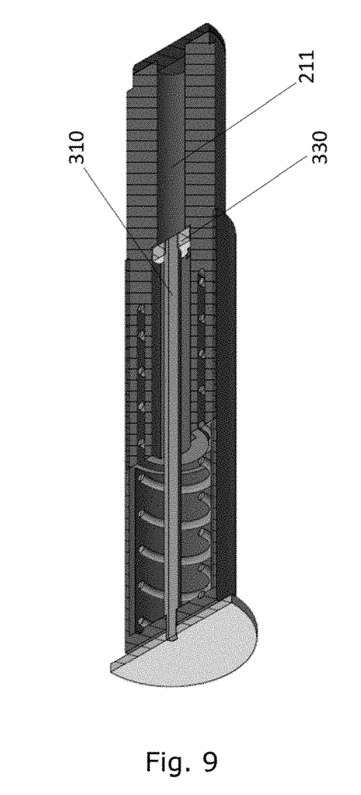

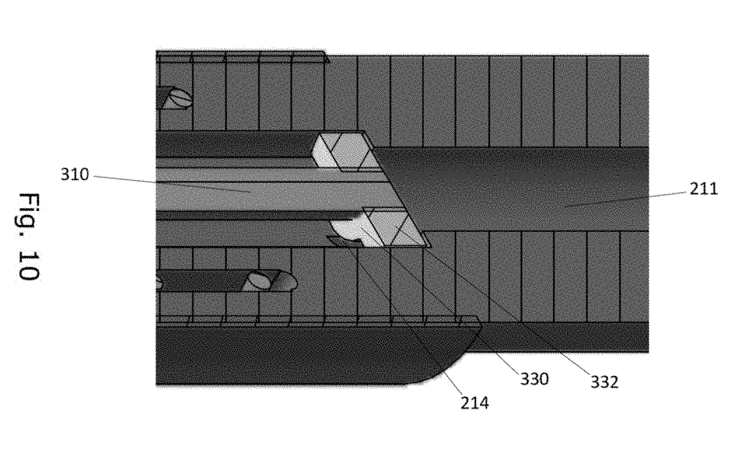

The cavity 214 displaces the same distance as the piston 210, as it is part thereof. In order to recharge the piston unit 200, the lock plate 330 must find its way back to the cavity 214. This is done by continuing to rotate the threaded cylindrical rod 310, whereby the lock plate 330 travels towards the free end of said threaded cylindrical rod 310 until it reaches the bottom of the recess 212, and the protrusion 332 enters the cavity 214. The rotation of the threaded cylindrical rod 310 must then be reversed in order for the lock plate 330 to retract the piston 210 into the piston bore 300. FIG. 8 shows a side view of a piston unit during a recharging operation, as well as a cross-section (A-A) of said view. FIG. 9 shows a perspective view of the cross-section in FIG. 8, and FIG. 10 shows a close-up view of FIG. 9. Here, the lock plate 330 has just reached the bottom of the recess 212.

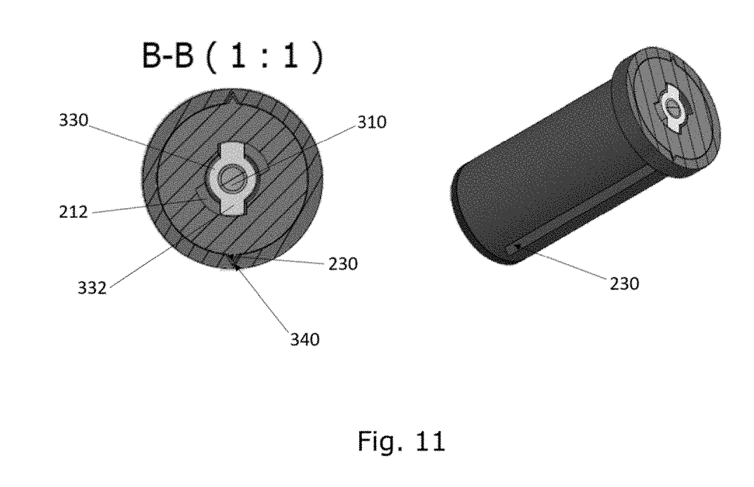

FIG. 11 shows a cross-section (B-B) of the piston unit in FIG. 10, as well as a perspective view of said cross-section (B-B). The inner surface of the piston bore 300 is shown with two guide tracks 340, and the outer surface of the piston 210 is shown with two protrusions 230 configured for slidably engaging with said guide tracks 340. This configuration avoids that the piston 210 will rotate within the piston bore 300 during the recharging operation.

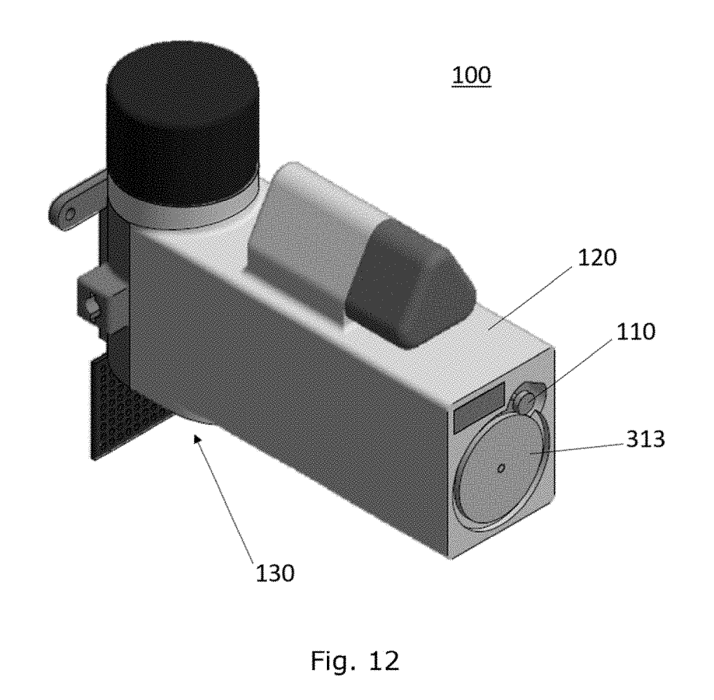

FIG. 12 shows a perspective view of an automatic rechargeable trap comprising a killing means comprising a piston unit in accordance with various embodiments of the invention.

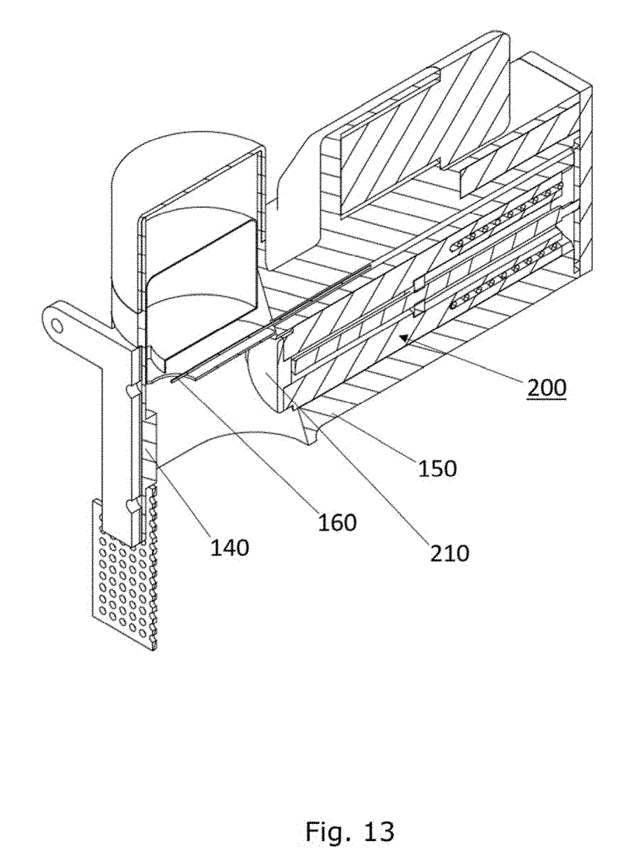

FIG. 13 is a cross-section of an automatic rechargeable trap comprising a killing means comprising a piston unit in accordance with various embodiments of the invention. The automatic rechargeable trap 100 comprises a housing 120 with a rat and mouse entry opening 130 positioned in the side wall 140 and in the base wall 150. The piston unit 200 is positioned at a level above the level of the rat and/or mouse entry opening 130, such that a rat or mouse can reach the piston 210 when standing within the housing 120 on their hind legs, while activating a trigger rod 160 with its head.

What is claimed is:

1. An automatic rechargeable trap, comprising:
a) a spring driven and/or gas pressure driven killing means; and
b) species monitoring means configured for determining the species by monitoring the degree of advancement of the killing means during an individual triggering.

2. An automatic rechargeable trap according to claim 1, further comprising
c) kill monitoring means configured for determining the number of kills by monitoring the number of triggering of the killing means.

3. An automatic rechargeable trap according to claim 1, further comprising d) a transmitter unit configured for receiving monitoring data from the species monitoring means and/or from the kill monitoring means, and configured for transmitting the received monitoring data.

4. An automatic rechargeable trap according to claim 1, further comprising a housing with a rat and mouse entry opening positioned in the side wall and/or in the bottom wall;
and wherein the spring driven and/or gas pressure driven killing means is positioned at a level above the level of the rat and/or mouse entry opening, such that a rat or mouse can reach the killing means when standing within the housing on their hind legs.

5. An automatic rechargeable trap according to claim 1, wherein the spring driven and/or gas pressure driven killing means comprises a piston, and wherein the piston, after a triggered release, is configured to hold its position for a predefined period of time.

6. An automatic rechargeable trap according to claim 5, wherein the species monitoring means is configured for monitoring the degree of advancement of the piston during the predefined period of time that the piston holds its position during a triggered release.

7. An automatic rechargeable trap according to claim 1, further comprising a counter configured for calculating the number of rats and mice killed by said killing means during a period of time.

8. An automatic rechargeable trap according to claim 1, wherein the spring driven and/or gas pressure driven killing means comprises a piston, and wherein the piston, after a triggered release, is returned to a charged position within a piston bore by a motor unit, and wherein a) the motor operating time needed to return the piston to a charged position and/or b) the force needed by the motor to return the piston to a charged position and/or c) the number of motor shaft revolutions needed to return the piston to a charged position and/or d) measuring the power consumption needed to return the piston to a charged position, are used by the species monitoring means for monitoring the degree of advancement of the piston.

9. An automatic rechargeable trap according to claim 1, wherein the species monitoring means is configured for differentiating between rats and mice by using the degree of advancement of the piston during a triggered release.

10. An automatic rechargeable trap according to claim 1, wherein the spring driven and/or gas pressure driven killing means is a piston unit comprising:
a piston; and
a piston bore;
Wherein the piston bore comprises:
a1) a threaded cylindrical rod adapted to rotate around its central axis within the piston bore cavity; wherein the first end of the threaded cylindrical rod is adapted for engagement with a motor unit, and wherein the second end is a free end;
b1) a spring positioned within the piston bore cavity, and around or alongside the threaded cylindrical rod; and
c1) a lock plate comprising i) a threaded opening configured for receiving the threaded cylindrical rod; and ii) a protrusion extending radially away from the threaded opening;
and wherein the piston comprises:
a2) a central channel adapted for receiving the threaded cylindrical rod, and wherein the upper part of the central channel further comprises a recess configured for receiving a protrusion of the lock plate; wherein the bottom part of the recess comprises a cavity configured for receiving said protrusion of the lock plate in a locking configuration when the lock plate is rotated around the central axis of the threaded cylindrical rod.

11. An automatic rechargeable trap according to claim 11, wherein the piston further comprises a peripheral channel running peripherally to the central channel, and configured for receiving one of the spring end portions.

12. An automatic rechargeable trap according to claim 11, wherein the first end of the threaded cylindrical rod is configured as a toothed wheel adapted for engagement with a motor unit.

13. An automatic rechargeable trap according to claim 11, wherein the inner surface of the piston bore comprises one or more guide tracks, and wherein the outer surface of the piston comprises one or more protrusions configured for slidably engaging with said guide tracks.
